(19) United States
(12) Patent Application Publication
(10) Pub. No.: US 2025/0351215 A1
(43) Pub. Date: Nov. 13, 2025

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Li NIU, Shenzhen (CN); Bo DAI, Shenzhen (CN); Ting LU, Shenzhen (CN); Yuan GAO, Shenzhen (CN)

(73) Assignee: ZTE CORPORATION, Shenzhen (CN)

(21) Appl. No.: 19/278,958

(22) Filed: Jul. 24, 2025

Related U.S. Application Data
(63) Continuation of application No. PCT/CN2023/091897, filed on Apr. 28, 2023.

(51) Int. Cl. H04W 76/20; H04W 72/02; H04W 92/18

(52) U.S. Cl. CPC H04W 76/20; H04W 72/02; H04W 92/18

(57) ABSTRACT

A wireless communication method is disclosed. The method comprises relaying, by a relay wireless communication terminal, Internet of Things, IoT, information between a wireless communication node and an IoT wireless communication terminal via an IoT Uu protocol stack of the relay wireless communication terminal and via a Uu protocol stack of the relay wireless communication terminal, wherein the IoT Uu protocol stack is used for a communication between the relay wireless communication terminal and the IoT wireless communication terminal, and the Uu protocol stack is used for a communication between the relay wireless communication terminal and the wireless communication node.

### CROSS-REFERENCE TO RELATED PATENT APPLICATIONS

This application claims the benefit of priority under 35 U.S.C. § 120 as a continuation of International Patent Application No. PCT/CN2023/091897, filed on Apr. 28, 2023, the disclosure of which is incorporated herein by reference in its entirety.

### TECHNICAL FIELD

This document is directed generally to wireless communications, and in particular to 5^{th} generation (5G) communications or 6^{th} generation (6G) communications.

### BACKGROUND

In recent years, Internet of Things (IoT) based on NB-IoT (Narrowband Internet of Things) and eMTC (enhanced Machine Type Communication) technologies has been widely used or tested in various applications such as smart grid, intelligent parking, intelligent transportation and logistics, smart energy management systems, etc., involving many vertical fields such as smart cities and smart homes. This has rapidly promoted the upgrading and transformation of traditional industries. For example, the smart parking system can meet the deep coverage requirements of underground scenarios, and can achieve various functions such as parking space search, parking lot monitoring, and zone information display based on multiple types of sensors. In the smart grid system, functions such as intelligent meter reading and autonomous fault reporting can be realized. The IoT system based on eMTC technology can realize vehicle tracking, item tracking, and can be applied to transportation and logistics industry, shared bicycle industry, etc.

### SUMMARY

The large-scale application of IoT technology will give rise to a more diverse market and technological demands, and new IoT applications will continue to emerge. It is foreseeable that a larger number of sensors, IoT devices, or other types of modules will penetrate into various traditional or emerging industries such as agriculture, industry, environmental protection, urban management, and human health. In a smart library, for example, all books may be equipped with electronic tags, and the movement of books throughout the library can be fully tracked, with real-time book searching, positioning, quantity or status statistics, and more. The warehousing and logistics industry may already be a highly automated industry, where administrators can achieve electronic item recording, querying, and tracking through RFID (Radio Frequency Identification) technology-based tags. However, the workload is still enormous, as specialized equipment is needed to read each tag in sequence. People expect more intelligent operations. Due to economic constraints, traditional agriculture may still not be as modernized as expected, but it will become more modernized and intelligent in the future. Various sensors can be used for real-time monitoring of crop growth conditions such as soil, water, light, fertility, pests, and crop growth, and monitoring data can be used to drive small controllers to adjust growth conditions in real-time and handle disasters in a timely manner. Some potential applications may relate to advanced wearable or medical devices, including patches that can be attached to teeth to monitor oral health or diet, and micro-robots that can enter blood vessels for disease treatment, and so on. Overall, these applications will present significantly different requirements from existing IoT applications. For example, the number of such devices will be enormous, the size of many devices will be very small, requiring extremely simple hardware structures, and even the inability to integrate batteries. In addition, even if these devices can integrate batteries, it may be difficult to ensure that a battery can last for a long time due to the wide variety of business models. However, due to the enormous number of these devices, charging or replacing batteries for them will become very difficult, requiring tremendous manpower and material resources, and may even become an impossible task.

This document relates to methods, systems, and computer program products for an IoT relay communication.

One aspect of the present disclosure relates to a wireless communication method. In an embodiment, the wireless communication method includes: relaying, by a relay wireless communication terminal, Internet of Things, IoT, information between a wireless communication node and an IoT wireless communication terminal via an IoT Uu protocol stack of the relay wireless communication terminal and via a Uu protocol stack of the relay wireless communication terminal, wherein the IoT Uu protocol stack is used for a communication between the relay wireless communication terminal and the IoT wireless communication terminal, and the Uu protocol stack is used for a communication between the relay wireless communication terminal and the wireless communication node.

Another aspect of the present disclosure relates to a wireless communication method. In an embodiment, the wireless communication method includes: communicating, by a wireless communication node, Internet of Things, IoT, information with an IoT wireless communication terminal via a relay wireless communication terminal through a Uu protocol stack of the wireless communication node.

Another aspect of the present disclosure relates to a wireless communication method. In an embodiment, the wireless communication method includes: communicating, by an Internet of Things, IoT, wireless communication terminal, IoT information with a wireless communication node via a relay wireless communication terminal through an IoT Uu protocol stack of the IoT wireless communication terminal.

Another aspect of the present disclosure relates to a wireless communication terminal. In an embodiment, the wireless communication terminal includes a communication unit and a processor. The processor is configured to: relay, via the communication unit, Internet of Things, IoT, information between a wireless communication node and an IoT wireless communication terminal via an IoT Uu protocol stack of the relay wireless communication terminal and via a Uu protocol stack of the relay wireless communication terminal, wherein the IoT Uu protocol stack is used for a communication between the relay wireless communication terminal and the IoT wireless communication terminal, and the Uu protocol stack is used for a communication between the relay wireless communication terminal and the wireless communication node.

Another aspect of the present disclosure relates to a wireless communication node. In an embodiment, the wireless communication node includes a communication unit and a processor. The processor is configured to: communicate, via the communication unit, Internet of Things, IoT, information with an IoT wireless communication terminal via a relay wireless communication terminal through a Uu protocol stack of the wireless communication node.

Another aspect of the present disclosure relates to a wireless communication terminal. In an embodiment, the wireless communication terminal includes a communication unit and a processor. The processor is configured to: communicate, via the communication unit, IoT information with a wireless communication node via a relay wireless communication terminal through an IoT Uu protocol stack of the IoT wireless communication terminal.

Various embodiments may preferably implement the following features:

Preferably or in some embodiments, the IoT Uu protocol stack comprises at least one of:
an IoT Uu Layer 1 entity;
an IoT Uu Layer 2 entity or sub-entity; or
an IoT Uu Layer 3 entity.

Preferably or in some embodiments, wherein at least one of the following applies:
the IoT Uu Layer 1 entity performs at least one of a modulation, a demodulation, a channel coding, a channel decoding, a signal generation, a physical layer procedure, or a physical layer measurement for the communication between the relay wireless communication terminal and the IoT wireless communication terminal;
the IoT Uu Layer 2 entity or sub-entity performs at least one of a data transfer, a conflict resolution, an assembling, a dissembling, a radio resource selection, an encryption, a decryption, a control procedure, or a message generation for the communication between the relay wireless communication terminal and the IoT wireless communication terminal; and
the IoT Uu Layer 3 entity performs at least one of: an encryption, a decryption, a control procedure, or a message generation for the communication between the relay wireless communication terminal and the IoT wireless communication terminal.

Preferably or in some embodiments, the IoT Uu Layer 2 sub-entity adds or parses an IoT Uu Layer 2 header.

Preferably or in some embodiments, the IoT Uu Layer 2 header comprises at least one of: a source identifier, ID, of a data packet, a target ID of a data packet, a message type of a data packet, an identity of the IoT wireless communication terminal, an identity of the relay wireless communication terminal, or an identity of a destination network node of a data packet.

Preferably or in some embodiments, the Uu protocol stack comprises at least one of:
a physical, PHY, entity;
a Medium Access Control, MAC, entity;
a Radio Link Control, RLC, entity;
a Packet Data Convergence Protocol, PDCP, entity;
a Service Data Adaptation Protocol, SDAP, entity;
a Radio Resource Control, RRC, entity; or
a Layer B entity.

Preferably or in some embodiments, the Layer B entity performs at least one of:
a data transfer;
a mapping between the IoT Uu protocol stack and a Data Radio Bearer, DRB, a Radio Bearer, RB, a Signaling Radio Bearer, SRB or a Radio Link Control, RLC, channel, for the communication between the relay wireless communication terminal and the wireless communication node;
adding a header carrying information of the IoT wireless communication terminal to a Layer 1, Layer 2, or Layer 3 Protocol Data Unit, PDU, indicating the Layer 1, Layer 2, or Layer 3 PDU being destinated to the IoT wireless communication terminal; or
parsing and removing a header carrying information of the IoT wireless communication terminal of a Layer 1, Layer 2, or Layer 3 PDU indicating the Layer 1, Layer 2, or Layer 3 PDU being received from the IoT wireless communication terminal.

Preferably or in some embodiments, the relay wireless communication terminal performs at least one of:
receiving, by an IoT Uu Layer 1 entity, an uplink data packet from the IoT wireless communication terminal and retrieving a Layer 2 PDU or a Layer 2 sub-PDU;
delivering, by an IoT Uu Layer 2 entity or an IoT Uu Layer 2 sub-entity, a Layer 2 PDU or a Layer 2 sub-PDU to an SDAP entity, a PDCP entity, an RLC entity, an RRC entity, or a Layer B entity to generate an SDAP PDU, a PDCP PDU, an RLC PDU, an RRC PDU, or a Layer B PDU to be transmitted to the wireless communication node;
receiving, by a PHY entity, a downlink data packet from the wireless communication node; or
delivering, by an SDAP entity, a PDCP entity, an RLC entity, an RRC entity, or a Layer B entity, an SDAP PDU, a PDCP PDU, an RLC PDU, an RRC PDU, or a Layer B PDU retrieved from a downlink data packet from the wireless communication node to generate a Layer 2 PDU or a Layer 2 sub-PDU to be transmitted to the IoT wireless communication terminal.

Preferably or in some embodiments, the relay wireless communication terminal receives a configuration for a DRB, an RB, an RLC channel, or a Signal Radio Bearer, SRB, from the wireless communication node for the communication between the relay wireless communication terminal and the wireless communication node.

Preferably or in some embodiments, the configuration comprises at least one of:
a DRB identifier, ID;
a flow ID;
an RB ID;
an SRB ID;
an RLC channel ID;
a configuration of an SDAP entity;
a configuration of a PDCP entity;
a configuration of an RLC entity;
a configuration of a MAC entity; or
a configuration of a PHY entity.

Preferably or in some embodiments, the relay wireless communication terminal receives an IoT configuration from the wireless communication node for the IoT Uu protocol stack.

Preferably or in some embodiments, the IoT configuration comprises at least one of:
an IoT configuration ID;
a configuration of an IoT Uu layer 1 entity;
a configuration of an IoT Uu layer 2 sub-entity;
a configuration of an IoT Uu layer 2 entity; or
a configuration of an IoT Uu layer 3 entity.

Preferably or in some embodiments, the IoT configuration is associated with a configuration for a DRB, an RB, an RLC channel, or an SRB for the communication between the relay wireless communication terminal and the wireless communication node.

Preferably or in some embodiments, the relay wireless communication terminal performs the communication between the relay wireless communication terminal and the wireless communication node via an SRB with an RRC message, and the RRC message comprises at least one of:
an indication indicating that the RRC message is used for relaying a data packet from the IoT wireless communication terminal;
an indication indicating that a PDU carried by the RRC message is from the IoT wireless communication terminal;
a PDU from the IoT wireless communication terminal;
a source ID or a target ID;
an identity of the IoT wireless communication terminal;
a message type of the RRC message; or
information for at least one of an inventory or a contention resolution.

Preferably or in some embodiments, the wireless communication node performs a communication between the relay wireless communication terminal and the wireless communication node via an SRB with an RRC message, and the RRC message comprises at least one of:
an indication indicating that the RRC message is used for relaying a data packet from the IoT wireless communication terminal;
an indication indicating that a PDU carried by the RRC message is from the IoT wireless communication terminal;
a PDU from the IoT wireless communication terminal;
a source ID or a target ID;
an identity of the IoT wireless communication terminal;
a message type of the RRC message; or
information for at least one of an inventory or a contention resolution.

Preferably or in some embodiments, the IoT wireless communication terminal receives an IoT configuration from the wireless communication node via the relay wireless communication terminal for the IoT Uu protocol stack.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of an IoT relay communication according to an embodiment of the present disclosure.

FIG. 2 shows a schematic diagram of an IoT relay communication according to an embodiment of the present disclosure.

FIG. 3 shows a schematic diagram of an IoT relay communication according to an embodiment of the present disclosure.

FIG. 4 shows a schematic diagram of an IoT relay communication according to an embodiment of the present disclosure.

FIG. 5 shows a schematic diagram of an IoT relay communication according to an embodiment of the present disclosure.

FIG. 6 shows a schematic diagram of an IoT relay communication according to an embodiment of the present disclosure.

FIG. 7 shows a schematic diagram of an IoT relay communication according to an embodiment of the present disclosure.

FIG. 8 shows a schematic diagram of an IoT relay communication according to an embodiment of the present disclosure.

FIG. 9 shows a schematic diagram of an IoT relay communication according to an embodiment of the present disclosure.

FIG. 10 shows a schematic diagram of an IoT relay communication according to an embodiment of the present disclosure.

FIG. 11 shows a schematic diagram of an IoT relay communication according to an embodiment of the present disclosure.

FIG. 12 shows a schematic diagram of an IoT relay communication according to an embodiment of the present disclosure.

FIG. 13 shows a schematic diagram of an IoT relay communication according to an embodiment of the present disclosure.

FIG. 14 shows a schematic diagram of a procedure according to an embodiment of the present disclosure.

FIG. 15 shows an example of a schematic diagram of a wireless communication terminal according to an embodiment of the present disclosure.

FIG. 16 shows an example of a schematic diagram of a wireless communication node according to an embodiment of the present disclosure.

FIGS. 17 to 19 show flowcharts of wireless communication methods according to some embodiments of the present disclosure.

### DETAILED DESCRIPTION

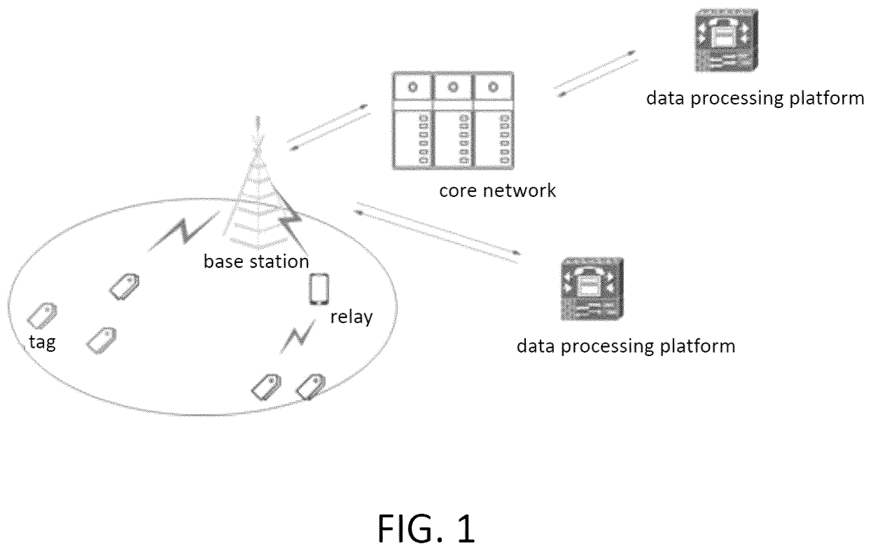

In some embodiments, a large-scale deployment of IoT may be limited by sensor energy consumption, deployment, and maintenance costs. Wireless powered communication network (WPCN), also known as passive IoT, may be a breakthrough for solving such IoT application scenarios. FIG. 1 shows a wireless powered communication network according to an embodiment of the present disclosure.

As illustrated in FIG. 1, the data processing platform is responsible for managing, operating, and maintaining tag data. The core network is responsible for conveying the data from the data processing platform to the base station, or conveying the data from the base station to the data processing platform. The base station may be responsible for the operations on the tags and sending the data from the core network to the tags or sending the tag data to the core network. In scenarios with relays, the relays may be responsible for converting base station commands into commands that tags can recognize and sending them to the tags.

In some embodiments, an IoT UE (user equipment) (e.g., an Ambient Internet of Things (AIoT) UE) has the characteristic of low power consumption, simple protocol stack. The network that supports an access service for this UE also has the characteristic of simple protocol stack. The architecture of this network may be called as the network architecture with a simple stack.

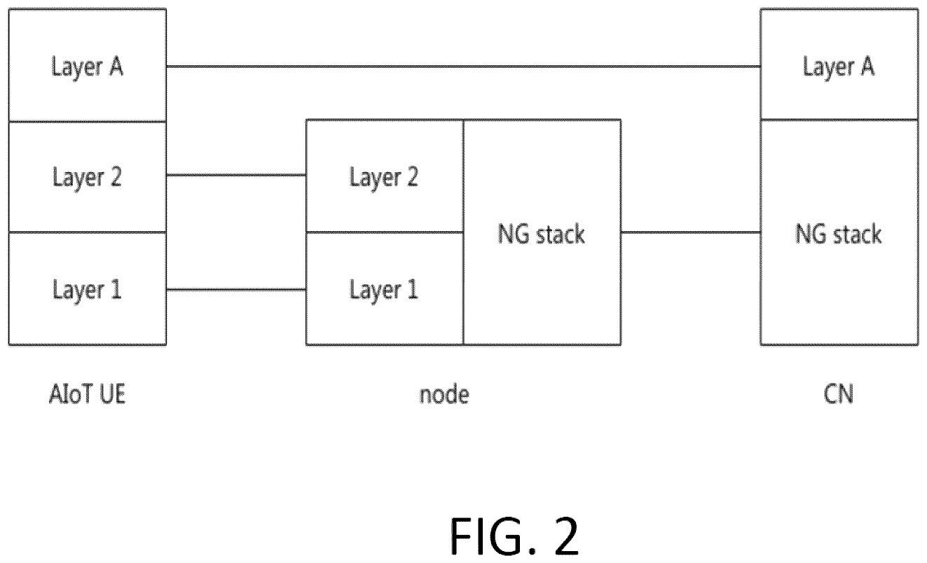

In some embodiments, the IoT Uu interface is between the IoT UE and the node (such as gNB or BS (base station)). In FIG. 2, the Uu Layer 1 entity and the Uu Layer 2 entity are terminated between the IoT UE and the node. The Layer A entity is terminated between the UE and the network function (e.g., a network node) of the core network (such as an AMF (Access and Mobility Management Function)). The NG (next generation) stack(s) are terminated between the node and the network function of the core network (such as AMF). The term entity used in this document indicates an entity or a function performs certain protocol(s) or operation(s), which can be implemented by using a hardware platform and/or a program code.

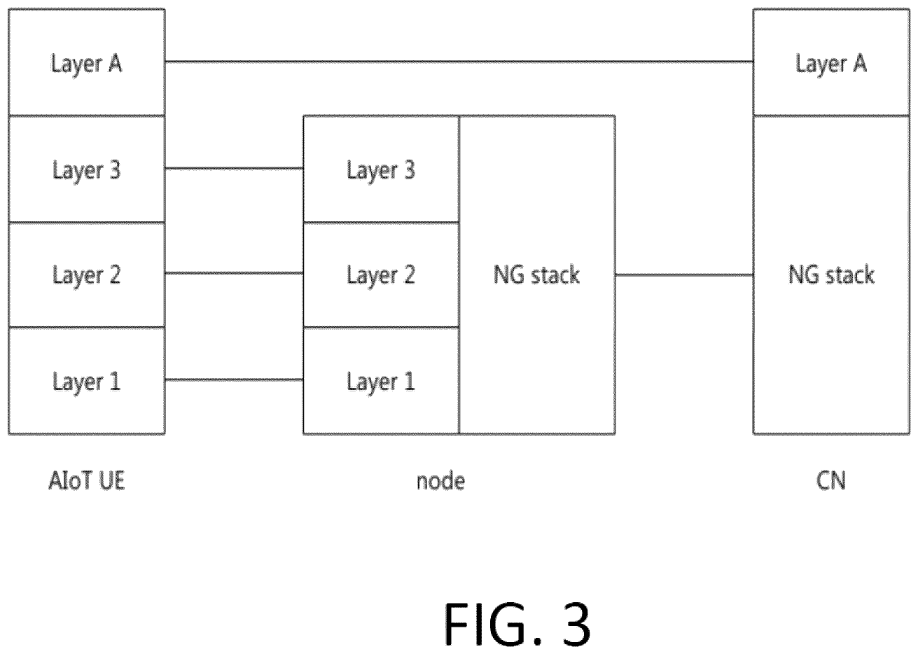

In FIG. 3, the Uu Layer 1 entity, the Uu Layer 2 entity and the Uu Layer 3 entity are terminated between the IoT UE and the node. The Layer A entity is terminated between the IoT UE and the network function of the core network (such as AMF). The NG stack(s) are terminated between the node and the network function of the core network (such as AMF).

In some embodiments, the functions of the Uu Layer 1 entity include at least one of the following: modulation and demodulation, channel coding and decoding, signal generation, physical layer procedures, or physical layer measurement.

In some embodiments, the functions of the Uu Layer 2 entity include at least one of the following: data transfer, conflict resolution, assembling, disassembling, radio resource selection, encryption, decryption, control procedure, or message generation.

In some embodiments, the functions of the Uu Layer 3 entity include at least one of the following: encryption, decryption, or control procedure, message generation.

In some embodiments, the functions of the Layer A entity include at least one of the following: encryption, decryption, control procedure, or message generation.

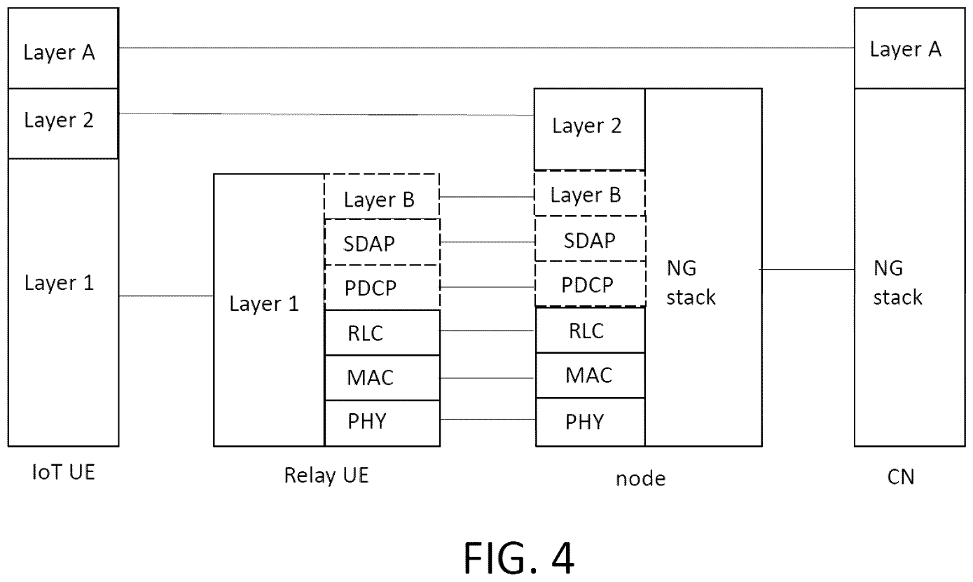

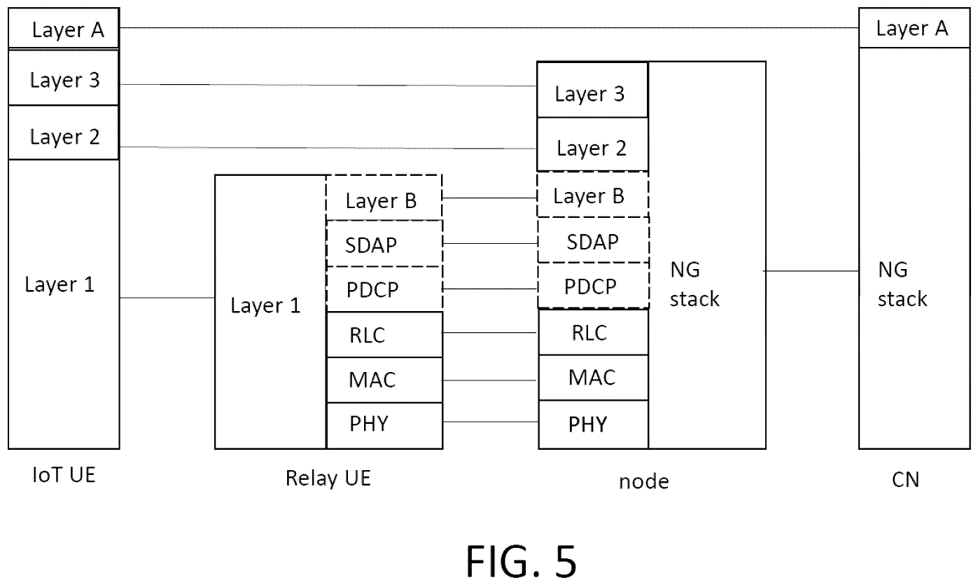

In some embodiments, the power of the IoT UE might be limited, so that the communication distance of the IoT UE is limited. To increase the communication distance, a relay UE (such as an NR UE) may be used to relay the IoT UE's data to the node and/or the core network (see FIGS. 4 and 5).

In some embodiments of the present disclosure, the interface between the IoT UE and the relay UE may be referred to as IoT Uu interface, the interface between the node and the relay UE may be referred to as Uu interface, and the interface between the node and the core network may be referred to as NG interface.

In some embodiments, the functions of the IoT Uu Layer 1 entity (also referred to as IoT Uu Layer 1, IoT Layer 1, or Layer 1) include at least one of the following: modulation and demodulation, channel coding and decoding, signal generation, physical layer procedures, or physical layer measurement.

In some embodiments, the functions of the IoT Uu Layer 2 entity (also referred to as IoT Uu Layer 2, IoT Layer 2, or Layer 2) include at least one of the following: data transfer, conflict resolution, assembling, disassembling, radio resource selection, encryption, decryption, control procedure, or message generation.

In some embodiments, the functions of the IoT Uu Layer 3 entity (also referred to as IoT Uu Layer 3, IoT Layer 3, or Layer 3) include at least one of the following: encryption, decryption, or control procedure, message generation.

In some embodiments, the data that is transmitted between the IoT UE and the core network may be referred to as the CN (core network) PDU (Protocol Data Unit).

In some embodiments, the data that is transmitted between the IoT Layer 1 entity and the IoT Layer 2 entity in the relay UE or IoT UE may be referred to as the Layer 2 PDU.

In some embodiments, the data that is transmitted between the IoT Layer 2 part1 entity and IoT Layer 2 part2 entity in the relay UE or IoT UE may be referred to as the Layer 2 sub-PDU.

In some embodiments, the data that is transmitted between the IoT Layer 2 and Layer 3 entities in the relay UE or IoT UE may be referred to as the Layer 3 PDU.

In the paragraphs below, details will be described along with many aspects, but the present disclosure is not limited to the paragraphs below.

### Aspect 1 (Architecture 1)

FIGS. 4 and 5 show examples of the relay architecture according to some embodiments of the present disclosure.

In some embodiments, the relay UE may relay data between the IoT UE and the node via a DRB (Data Radio Bearer), an RB (Radio Bearer) or an RLC channel (Radio Link Control).

In some embodiments, the relay UE may not disassemble the Layer 2 PDU.

In some embodiments, for the IoT UE, the IoT UE may not be able to distinguish the relay UE and the node. In such a case, when IoT UE communicate with the relay UE, the IoT Uu protocol stack of the IoT UE may include the Layer 1, Layer 2, and Layer A. Alternatively, the IoT Uu protocol stack of the IoT UE may include the Layer 1, Layer 2, Layer 3 and Layer A.

In some embodiments, for the relay UE, the relay UE may relay the data packet from IoT UE to the node. Thus, in addition to the IoT Uu protocol stack, such as Layer 1, the relay UE also have the Uu protocol stack. In uplink (UL), if the data packet from the IoT UE needs to be transmitted to the core network via the user plane, the relay UE may be configured with a DRB to process the data packet. If the data packet from the IoT UE needs to be transmitted to the core network via the user plane or the control plane, or the data packet need to be encrypted, the relay UE may be configured with a radio bearer to process the data packet. If the data packet needs the function of the retransmission, and not the encryption, the relay UE may be configured with an RLC channel to process the data packet.

In some embodiments, if the DRB is configured, the UL data packet from the IoT UE is processed sequentially by the SDAP (Service Data Adaptation Protocol) protocol entity (also referred to as SDAP), PDCP (Packet Data Convergence Protocol) protocol entity (also referred to as PDCP), RLC (Radio Link Control) protocol entity (also referred to as RLC), MAC (Medium Access Control) protocol entity (also referred to as MAC), and PHY (Physical) protocol entity (also referred to as PHY), and transmit to the node via the Uu interface.

In some embodiments, if the RB is configured, the UL data packet from the IoT UE is processed sequentially by the PDCP, RLC, MAC, and PHY, and transmit to the node via the Uu interface.

In some embodiments, if the RLC channel is configured, the UL data packet from the IoT UE is processed sequentially by the RLC, MAC, and PHY, and transmit to the node via the Uu interface.

In some embodiments, for downlink (DL), the process procedure is opposite to uplink, and details of downlink can be extrapolated from the paragraphs above.

In some embodiments, for the node, the node may receive the data packet or information from the IoT UE and transmit it to the core network. In some embodiments, the node may not only have the Uu protocol stack corresponding to the relay UE, such as PHY, MAC, RLC, PDCP (if configured), and SDAP (if configured), but also have the interface stacks to communicate with the core network, such as the NG stack.

In some embodiments, the IoT Uu Layer 1 is terminated between the IoT UE and the relay UE.

In some embodiments, for uplink, if the IoT UE needs to transmit certain information to the core network, it may generate a CN PDU carrying the certain information by using the Layer A. For example, for a read command procedure, when the IoT UE receive a read message, it may generate information according to the content of the read message, encrypt the generate information and produce a CN PDU carrying the encrypted information. Subsequently, the IoT UE may deliver this CN PDU to the lower Layer (e.g., the Layer 3 or the Layer 2). For Layer 3, it may add some formations to the CN PDU, or generate a message and encrypt the generated message to generate a Layer 3 PDU, and then deliver the Layer 3 PDU to the lower Layer. For the Layer 2, it may add some formations or some headers to the CN PDU or the Layer 3 PDU and encapsulate the CN PDU or the Layer 3 PDU to generate a Layer 2 PDU. For example, the Layer 2 may add a header to indicate the message type, the source ID and so on. Then, the IoT UE could deliver the Layer 2 PDU to the Layer 1. For Layer 1, it may modulate the Layer 2 PDU, and generate UL signals to be transmitted to the relay UE.

In some embodiments, the relay UE may receive the UL signals via the Layer 1, restore the Layer 2 PDU, and then deliver this Layer 2 PDU to the SDAP (if present) or the RLC. The relay UE may process this PDU through the SDAP (if present), the PDCP (if present), the RLC, the MAC, the PHY, and transmit this PDU to the node.

In some embodiments, the node may receive the UL signals from the relay UE, process it through the PHY, MAC, RLC, PDCP (if present), SDAP (if present) and restore the Layer 2 PDU. The node may parse the Layer 2 PDU, and obtain the information carried in the Layer 2 PDU by the Layer 2 and optional Layer 3. The node could discriminate the identity of the IoT UE, and create the UE context or resource for the IoT UE. The node could store the relationship between the IoT UE and the relay UE. If certain information or data packet(s) need to be sent to the core network, the node may generate a message, and transmit it to the core network via the NG stack. For example, the node may determine that the Layer 2 PDU carry the information sent to the core network according to the message type in the PDU, restore the CN PDU, generate an NG message carrying this CN PDU, and transmit the NG message to the core network.

In some embodiments, for the core network, if it receives the NG message from the node, it may process this message and restore the CN PDU via the NG stack, and then deliver it to the Layer A. The Layer A may decode the CN PDU, and obtain the information carried in the CN PDU. For example, for the read procedure, when the core network receives an NG message carrying a CN PDU, it may extract the CN PDU and deliver it to the Layer A. The Layer A may decrypt the CN PDU and obtain the information in CN PDU.

In some embodiments, for downlink (DL), the process procedure is opposite to uplink, and details of downlink can be extrapolated from the paragraphs above.

With the configuration described above, the relay UE could forward the data packet from the IoT UE to the core network, and the relay UE does not disassemble the Layer 2 PDU, and discriminate the information carried in the Layer 2 PDU.

### Aspect 2 (Architecture 2)

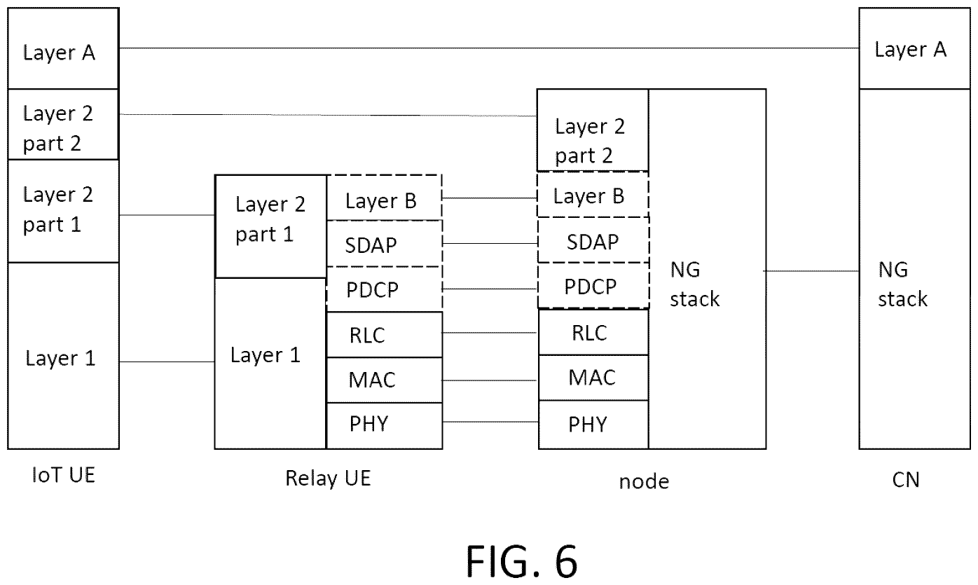

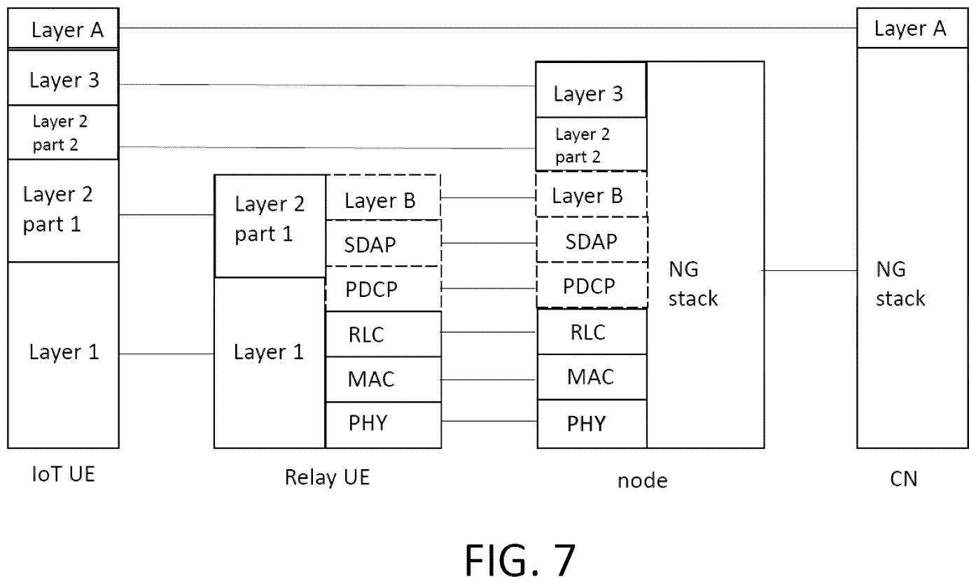

FIGS. 6 and 7 show examples of the relay architecture according to some embodiments of the present disclosure.

In some embodiments, the relay UE may relay data between the IoT UE and the node via a DRB (Data Radio Bearer), an RB (Radio Bearer) or an RLC channel (Radio Link Control).

In some embodiments, the Layer 2 is divided into two parts: the Layer 2 part2 and the Layer 2 part1.

In some embodiments, the relay UE has the capability of disassembling or assembling part(s) of the Layer 2 PDU. If the Layer 2 PDU could carry certain information, such as the source ID, the target ID, the message type, the identity of the IoT UE, the identity of the network, and/or the identity of the relay UE, the relay UE could disassemble some parts of the Layer 2 PDU and obtain information. That is, the relay UE may have a partial function of the Layer 2.

In some embodiments, the Layer 2 may be divided into two parts: the Layer 2 part1 and the Layer 2 part2. The IoT Uu Layer 1 and Layer 2 part1 are terminated between the IoT UE and the relay UE. The PDU that the Layer 2 part2 delivers to the Layer 2 part1 is referred to as the Layer 2 sub-PDU.

In some embodiments, for the Layer 2 in the IoT UE, in uplink, the IoT UE may add a header carrying certain information by using Layer 2, the information could include the source ID, the target ID, the message type, the identity of the IoT UE, the identity of the network, and/or the identity of the relay UE. In downlink, the IoT UE may parse the header in response to the information carried in the header matching with the IoT UE. For example, if the identity of the IoT UE indicated in the header matches with the IoT UE, the IoT UE may parse and remove the header and continues the subsequent process by using the Layer 2.

In some embodiments, for the Layer 2 part 1 in the relay UE, in uplink, if the relay UE receives UL signals from an IoT UE and restores a Layer 2 PDU through the IoT Uu Layer 1, the relay UE may parse the header in response to the information carried in the header matching with relay UE or IoT UE. For example, if the identity of the IoT UE indicated in the header matches with the IoT UE that is communicating with the relay UE, the relay UE may remove the header and deliver the Layer 2 sub-PDU to the corresponding SDAP or PDCP or RLC by using Layer 2 part 1.

In some embodiments, for the Layer 2 part 2 in the node, in uplink, if the node receives UL signals from a relay UE and restores a Layer 2 sub-PDU through the SDAP or PDCP or RLC, the node may resolve the remaining header and the PDU by using Layer 2 part 2 and optional layer 3. If certain information or data needs to be transmitted to the core node, the node may generate a message, and transmit it to the core network via the NG stack.

In some embodiments, the function of Layer 2 part 1 includes one or more of the following:
data transfer;
adding the header;
parsing and removing the header;
assembling and disassembling;
conflict resolution;
radio resource selection;
encryption;
decryption;
control procedure; and/or
message generation.

In some embodiments, the function of the Layer 2 part 2 includes one or more of the following:
data transfer;
adding the header; and/or
parsing and removing the header.

### Aspect 3 (Architecture 1—Relaying Via SRB)

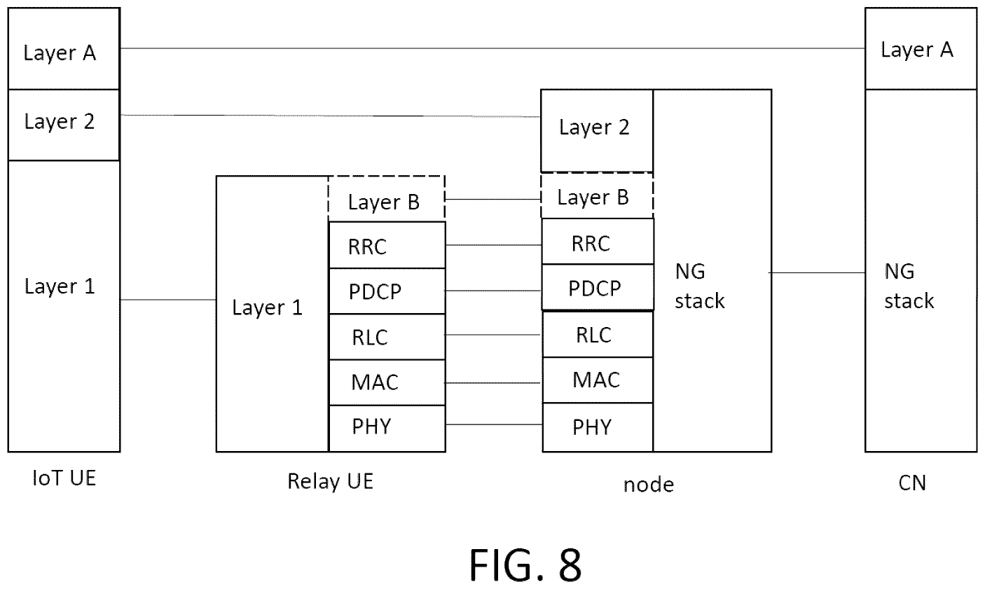

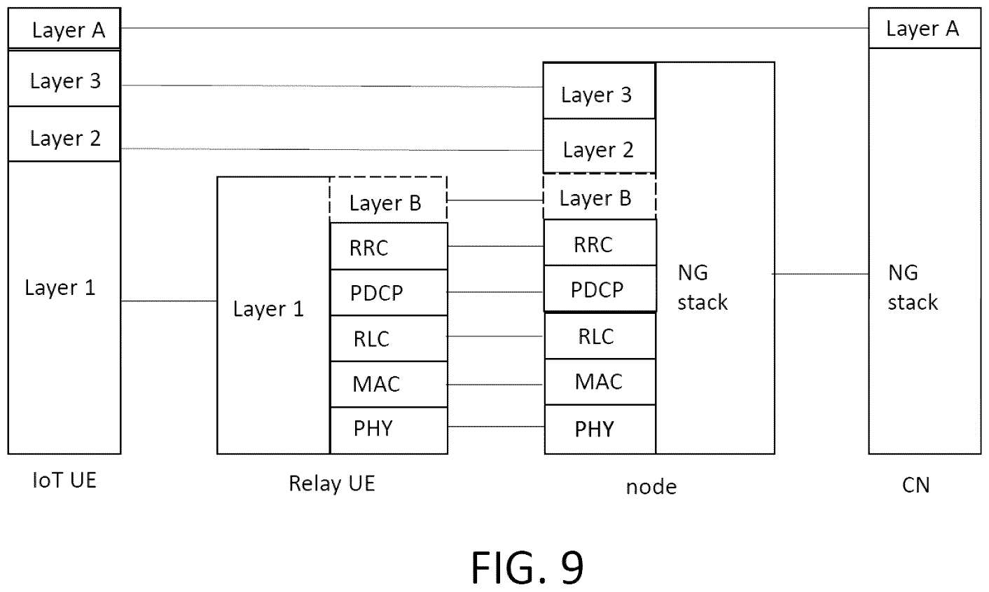

FIGS. 8 and 9 show examples of the relay architecture according to some embodiments of the present disclosure.

In some embodiments, the relay UE may relay the data packet from the IoT UE to the gNB (i.e., the node). The relay UE could transmit a message carrying the data packet from the IoT UE to the gNB. The relay UE may not only have the IoT Uu stacks, such as Layer 1, but also have the Uu stacks for communicating with the gNB. In uplink, if the data packet from the IoT UE need to be transmitted to the node, the relay UE may be configured with a signaling radio bearer (SRB) to transmit an RRC (Radio Resource Control) message carrying the data packet from the IoT UE. If the SRB is configured, the UL data packet from the IoT UE is processed sequentially by the RRC, PDCP, RLC, MAC, PHY, and transmit to the gNB via the Uu interface. For downlink, the process procedure is opposite to uplink, and details of downlink can be extrapolated from the paragraphs above.

As illustrated in FIGS. 8 and 9, the IoT Uu Layer 1 is terminated between the IoT UE and the relay UE. For uplink, a process procedure is described below.

In some embodiments, for the IoT UE, if it needs to transmit some information to the core network, it may generate a CN PDU carrying the information by using Layer A. Then, the IoT UE could deliver this CN PDU to the lower layer. Optionally, for layer 3 (if exist), it may add some formation to the CN PDU, or generate a message, encrypt the generated message, and then deliver the encrypted message to the lower layer. For Layer 2, it may add some formation or some headers, encapsulate the CN PDU, and generate a Layer 2 PDU. Then, the IoT UE could deliver the Layer 2 PDU to Layer 1. For the Layer 1, it may modulate, and generate UL signals to transmit the Layer 2 PDU to the relay UE.

In some embodiments, the relay UE may receive the UL signals via the Layer 1, restore the Layer 2 PDU, and then deliver this Layer 2 PDU to the RRC. The relay UE may generate an RRC message carrying this Layer 2 PDU. The RRC message could be ULInformationTransfer or another message. The relay UE may process this RRC message through the PDCP, RLC, MAC, PHY, and transmit this RRC message to the node.

In some embodiments, the RRC message could carry some information including the one or more of the following:
the indication that indicates this message is for relaying the data packet from the IoT UE;
the indication that indicates the carried PDU is from the IoT UE; and/or
the PDU, such as the Layer 2 PDU.

In some embodiments, the node, may receive the RRC message from the relay UE and restore the Layer 2 PDU. The node may disassemble or parse the Layer 2 PDU, and obtain the information carried in the PDU in the Layer 2 and the Layer 3 (optionally). If some information or the data packet need to be sent to the core network, the node may generate a message, and transmit the message to the core network via the NG stack. For example, the node may determine that the Layer 2 PDU may carry the information sent to the core network according to the message type in the PDU, restore the CN PDU, and generate an NG message carrying this CN PDU, and then transmit it to the core network.

In some embodiments, for the core network, if it receives a message from the node, it may process this message and restore the CN PDU via the NG stack, and then deliver it to the Layer A. The Layer A may decode the CN PDU, and obtain the information carried in the CN PDU. For example, for a read procedure, when the core network receives a NG message carrying a CN PDU, it may extract the CN PDU and deliver it to the Layer A. The Layer A may decrypt the CN PDU and obtain the information in the CN PDU.

In some embodiments, for downlink, the process procedure is opposite to uplink, and details of downlink can be extrapolated from the paragraphs above.

In this way, the relay UE could forward the data packet from the IoT UE to the network, and the relay UE does not disassemble or parse the Layer 2 PDU, and discriminate the information carried in the Layer 2 PDU.

### Aspect 4 (Architecture 2—Relaying Via SRB)

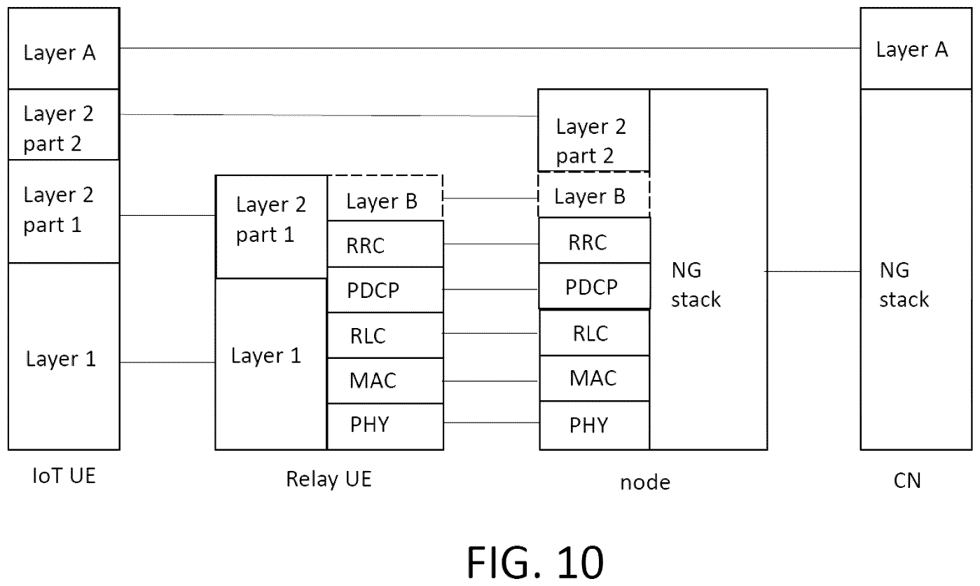

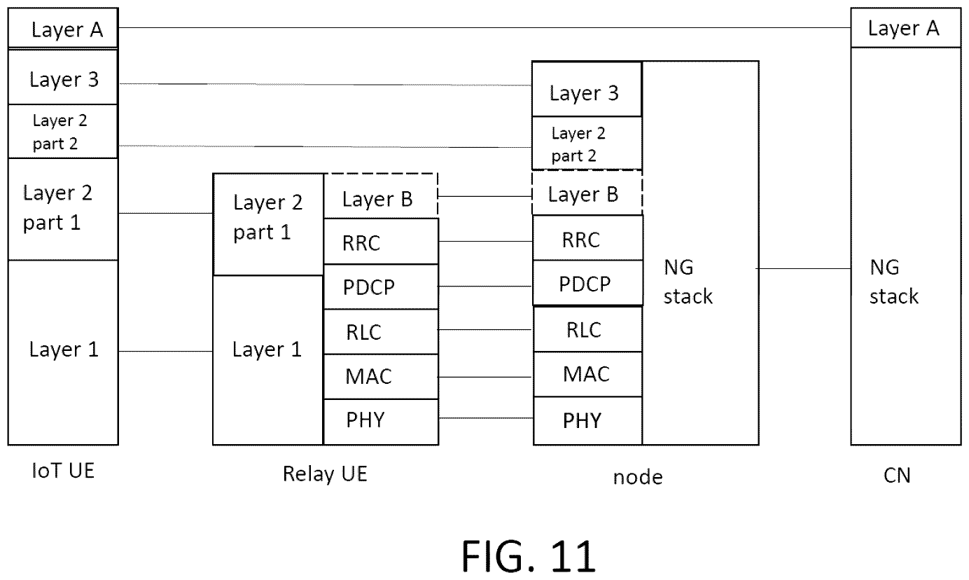

FIGS. 10 and 11 show examples of the relay architecture according to some embodiments of the present disclosure.

In some embodiments, the relaying is via the SRB. In some embodiments, the Layer 2 part2 and the Layer 2 part1 are used to transmit the data packet.

In some embodiments, the relay UE has the capability of disassembling or assembling some parts of the Layer 2 PDU.

In this embodiment, the Layer 2 may be divided into two parts: the Layer 2 part1 and the Layer 2 part2. The IoT Uu Layer 1 and Layer 2 part1 are terminated between the IoT UE and the relay UE.

In some embodiments, the PDU which the Layer 2 part2 delivers to the Layer 2 part1 is referred to as Layer 2 sub-PDU.

In some embodiments, the relay UE may receive the UL signals via the Layer 1, restore the Layer 2 sub-PDU, and deliver the Layer 2 sub-PDU to the RRC. The relay UE may generate an RRC message carrying this Layer 2 sub-PDU. The RRC message could be the ULInformationTransfer or another message. The relay UE may process this RRC message through the PDCP, RLC, MAC, PHY, and transmit it to the node.

In some embodiments, the RRC message could carry some information including the one or more of the following:
the indication that indicates this message is for relaying the data packet from the IoT UE;
the indication that indicates the carried PDU is from the IoT UE the PDU, such as the Layer 2 sub-PDU;
the source ID or the target ID;
the identity of the IoT UE; and/or
the message type.

### Aspect 5 (Architecture 3—Relaying Via SRB)

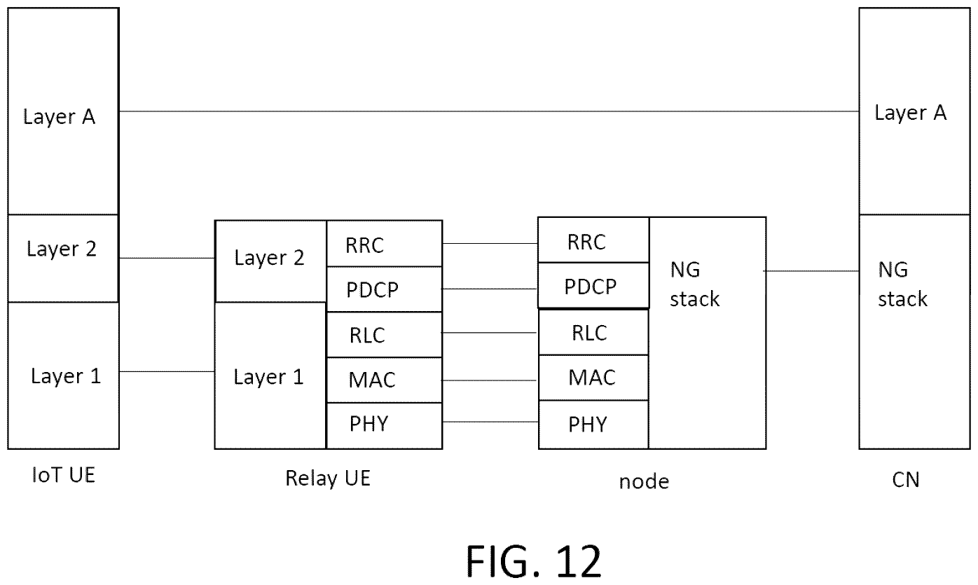

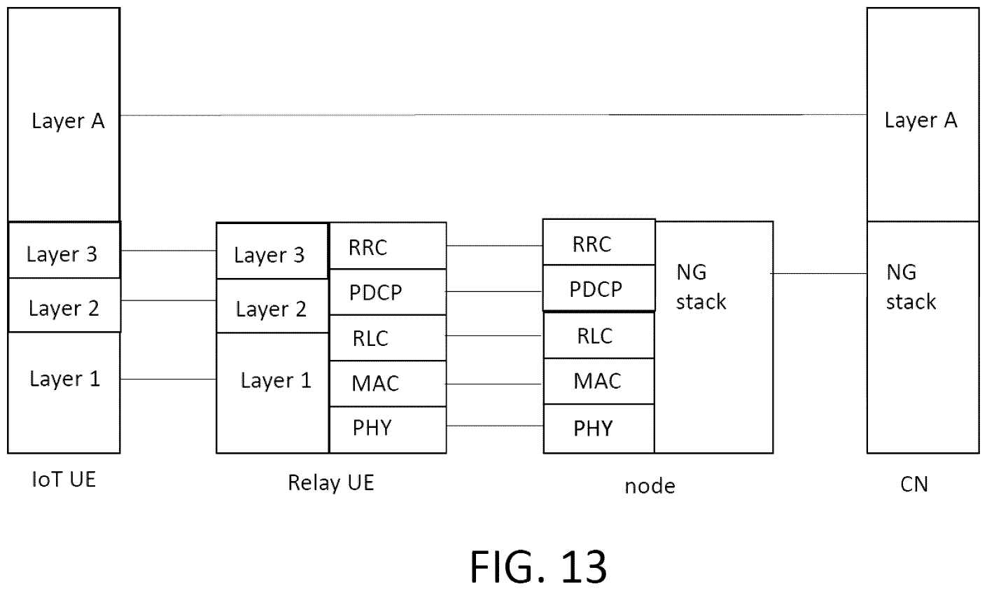

FIGS. 12 and 13 show examples of the relay architecture according to some embodiments of the present disclosure.

In some embodiments, the relaying is via the SRB.

In some embodiments, the relay UE may not have the capability of controlling the procedure (such as conflict resolution) in the IoT UE, but may have the capability of disassembling or assembling the Layer 2 PDU and the Layer 3 PDU (optional). If the Layer 2 PDU or the Layer 3 PDU could carry some information, such as the control information about conflict resolution, the relay UE could disassemble the Layer 2 PDU or the Layer 3 PDU, obtain the information, control the procedure, and assemble a PDU. That is, the relay UE has the function of the Layer 2 or the Layer 3.

In some embodiments, the IoT Uu Layer 1 and Layer 2 are terminated between the IoT UE and the relay UE.

In some embodiments, the IoT Uu Layer 1, Layer 2 and Layer 3 are terminated between the IoT UE and the relay UE.

In some embodiments, the relay UE may resolve the PDU from the IoT UE and obtain the information. If some information or a data packet need to be sent to the node or the core network, the relay UE may generate an RRC message carrying the information or the data packet. The RRC message could be the ULInformationTransfer, the UE information or another message. The relay UE may process this RRC message through the PDCP, RLC, MAC, PHY, and transmit the RRC message to the node.

In some embodiments, the RRC message could carry some information including the one or more of the following:
the indication that indicates this message is for relaying the data packet from the IoT UE;
the indication that indicates the carried PDU is from the IoT UE;
the PDU, such as the CN PDU;
the source ID or target ID;
the identity of the IoT UE;
the message type; and/or
the information about the inventory, the contention resolution, etc.

### Aspect 6 (Layer B)

In some embodiments, in the uplink (UL) transmission, the relay UE relays the data packet from the IoT UE to the node and/or the core network. In some embodiments, the relay UE may deliver the data packet received by IoT Uu Layer 1 or Layer 2 or Layer 3 entity or function to the DRB or the SRB or the RB or the RLC channel in Uu interface. In downlink (DL), the relay UE may deliver the data packet received from the Uu SDAP or RRC or PDCP or RLC to the IoT Uu Layer 1 or Layer 2 or Layer 3 entity or function. In some embodiments, the Layer B entity is used to mapping the data packet from the IoT Uu interface to the Uu interface.

In some embodiments, the relay UE could relay data packets from multiple IoT UEs to the node and/or the core network. In order to save the radio resource in the Uu interface, a DRB or SRB or RB or RLC channel could process the data packets from multiple IoT UEs. In some embodiments, the Layer B entity could map the data packets from multiple IoT UEs to a DRB, an SRB, a n RB, or an RLC channel in the UL transmission, and map the data packet from an SRB, a DRB, an RB, or an RLC channel to multiple IoT UEs.

In some embodiments, for the relay UE, a DRB, an SRB, an RB, or an RLC channel is configured to transmit the data packet from one or multiple IoT UEs. In uplink, if the relay UE receives UL signals from an IoT UE and restores a Layer X PDU (such as Layer 2 PDU, Layer 2 sub-PDU, Layer 3 PDU), it may deliver this Layer X PDU to the Uu SDAP of the corresponding DRB, or the Uu RRC of the corresponding SRB, or the Uu PDCP of the corresponding RB, or the Uu RLC of the corresponding RLC channel by the Layer B entity. In downlink, if the relay UE receives the data packet from the configured DRB or SRB or RB or RLC channel, and restores a Layer X PDU retrieved from the Uu SDAP or RRC or PDCP or RLC PDU, it may deliver this Layer X PDU to the corresponding IoT Uu Layer 1 or layer 2 or Layer 3 by the Layer B entity.

In some embodiments, for the node, a DRB, an SRB, an RB, or an RLC channel is configured to transmit the data packet from one or multiple IoT UEs. In uplink, if the node receives UL signals from a data packet from the configured DRB or SRB or RB or RLC channel, and restores a Layer X PDU retrieved from the Uu SDAP or RRC or PDCP or RLC PDU, the node may deliver this Layer X PDU to the IoT Uu Layer 2 or Layer 3 by the Layer B entity. In downlink, if the node receives the data packet of the IoT UE from the core network, and restores a Layer X PDU, it may deliver this Layer X PDU to IT Uu Layer 1 or Layer 2 or Layer 3 by the Layer B.

In some embodiments, if a DRB, an SRB, an RB, or an RLC channel is configured to transmit the data packet from multiple IoT UEs, the node and the relay UE may distinguish the IoT UE and transmit the data packet to the corresponding IoT UE. In order to the distinguish the IoT UE, the information about the IoT UE could be added in the Layer X PDU by the Layer B, and the information about the IoT UE could be the identity of the IoT UE. In uplink, the relay UE may add a header (e.g., a Layer B header) carrying the identity of the IoT UE to the Layer X PDU by the Layer B, the node may parse and remove the header, and obtain the identity of the IoT UE by the Layer B. In downlink, the node may add a header carrying the identity of the IoT UE to the Layer X PDU by the Layer B, the relay UE may parse and remove the header, and obtain the identity of the IoT UE by the Layer B.

In some embodiments, the Layer B could support at least one of the following functions:
data transfer;
mapping between the data packet from the IoT UE and an SRB, a DRB, an RB, or an RLC channel;
adding a header carrying the information about the IoT UE to a Layer X PDU of this IoT UE (e.g., from the IoT Uu Layer 1 or Layer 2 or Layer 3 of the IoT UE);
or parsing and removing a header carrying the information about the IoT UE of a Layer X PDU of this IoT UE.

### Aspect 7 (Relationship)

In some embodiments, the node could configure an SRB, a DRB, an RB, or an RLC channel for the relay UE to relay the data packet from the IoT UE. If a DRB is used, the node could transmit at least one of the DRB ID, the flow ID, the SDAP configuration, the PDCP configuration, the RLC configuration, the MAC configuration, and/or the PHY configuration to the relay UE. If an RB is used, the node could transmit at least one of the RB ID, the PDCP configuration, the RLC configuration, the MAC configuration, and/or the PHY configuration to the relay UE. If an RLC channel is used, the node could transmit at least one of the RLC channel ID, the RLC configuration, the MAC configuration, and/or the PHY configuration to the relay UE. If an SRB is used, the node could transmit at least one of the SRB ID, the RRC configuration, the PDCP configuration, the RLC configuration, the MAC configuration, and/or the PHY configuration to the relay UE.

In some embodiments, the node could transmit an IoT configuration for the relay UE to transmit or receive the data packet from the IoT UE. The IoT configuration could include one or more of the IoT configuration ID, IoT Layer 1 configuration, IoT Layer 2 part1 configuration, IoT Layer 2 configuration, and/or IoT Layer 3 configuration.

In some embodiments, the SRB, DRB, RB, or RLC channel could be related with the IoT configuration. The SRB ID, DRB ID, flow ID, RB ID, or RLC channel ID could be related with the IoT configuration ID or IoT configuration.

### Aspect 8 (Procedure)

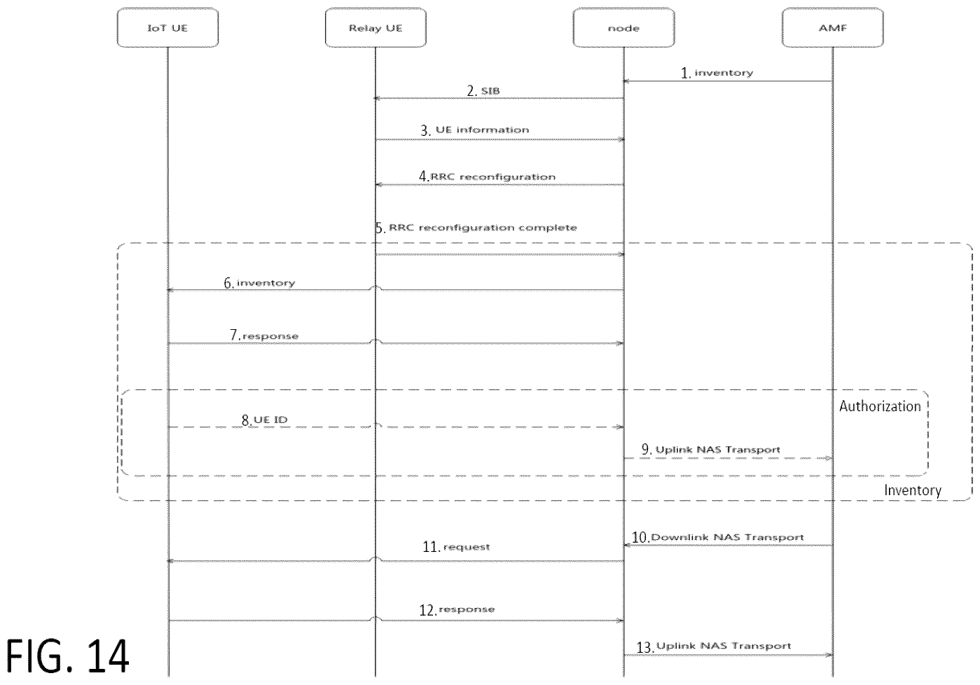

FIG. 14 shows an example a procedure according to some embodiments of the present disclosure.

In some embodiments, the procedure may include the steps described below.
1. The CN may trigger an inventory procedure and send the NG message carrying inventory information to the node.
2. The node may broadcast a system information about the IoT communication, including the IoT relay communication, for example, the node supports the IoT relay communication, and may allocate some resources for it.
3. The relay UE may send an RRC message, such as UE information, to the node, to request an IoT relay communication.
4. The node may send an RRC message such as the RRC reconfiguration to the relay UE to enable the IoT relay communication and allocate the dedicated resource for it.
5. The relay UE may respond the RRC message with an RRC complete message.
6. The node may trigger an inventory procedure and send a PDU carrying an inventor message to the relay UE. The relay UE may relay the PDU to the IoT UE.
7. The IoT UE may respond the inventory procedure and send a PDU carrying a response message to the relay UE. The relay UE may relay the response message to the node.

(In step 6 and step 7, some steps or messages may be omitted during the inventory procedure.)
8. The IoT UE may send a PDU carrying its identity to the relay UE and/or send an encrypted result according to the authentication algorithm as a CN PDU to the relay UE. The relay UE may relay the received PDU to the node.
9. The node may send an NG message carrying the CN PDU from the IoT UE to the CN.

(In step 8 and step 9 some steps or messages may be omitted during the authentication procedure.)
10. The CN may send an NG message carrying the CN PDU for the IoT UE to the node. For example, the CN PDU may be a read request message.
11. The node may send a PDU carrying the CN PDU to the relay UE, and the relay UE may relay it to IoT UE.
12. The IoT UE may send a PDU carrying a CN PDU to the relay UE, and the relay UE may relay it to the node.
13. The node may send an NG message carrying the CN PDU from the IoT UE to the CN. For example, the CN PDU may be a read response message.

In the paragraphs below, details will be described along with some examples, but the present disclosure is not limited to the example below.

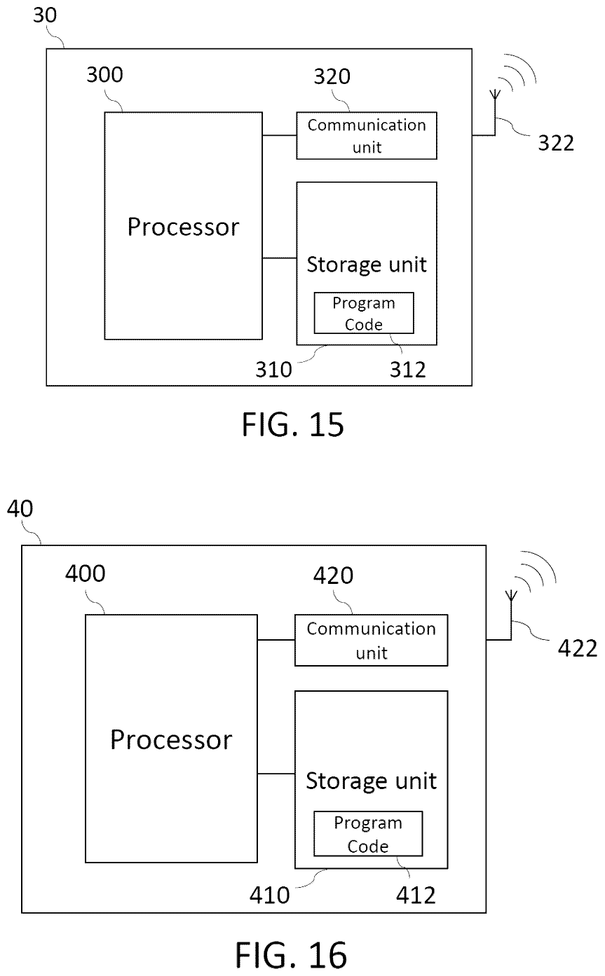

FIG. 15 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the relay UE or the IoT UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node or another wireless communication terminal 30.

In some embodiments, the wireless communication terminal 30 may be used to perform the operations of the relay UE or the IoT UE described above. In some embodiments, the processor 300 and the communication unit 320 collaboratively perform the operations described above. For example, the processor 300 performs operations and transmit or receive signals, message, and/or information through the communication unit 320.

FIG. 16 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the node, the core network, the network functions (e.g., the AMF, the PCF, etc.), or a network node in the core network described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from another wireless communication node or a wireless communication terminal.

In some embodiments, the wireless communication node 40 may be used to perform the operations of the node, the core network, the network functions (e.g., the AMF, the PCF, etc.), or a network node in the core network described in this disclosure. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a relay UE). In an embodiment, the wireless communication terminal may be implemented by using the wireless communication terminal 40 described above, but is not limited thereto.

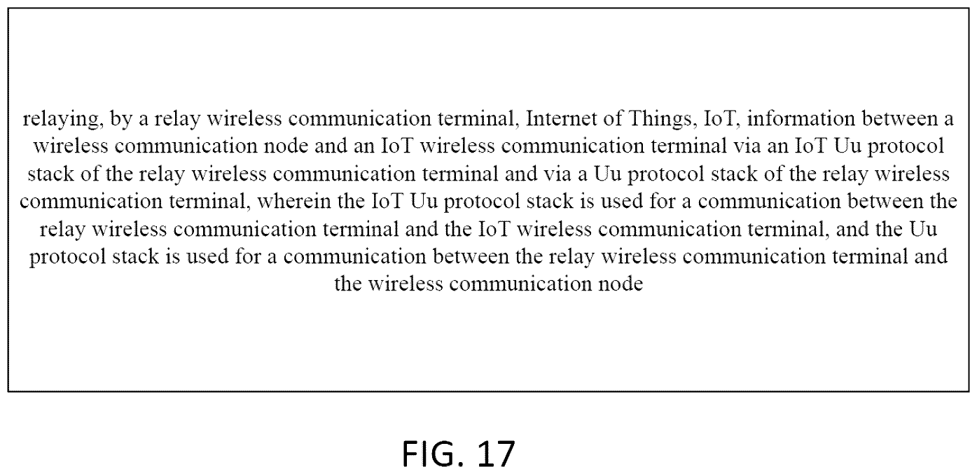

Referring to FIG. 17, in an embodiment, the wireless communication method includes: relaying, by a relay wireless communication terminal, Internet of Things, IoT, information between a wireless communication node and an IoT wireless communication terminal via an IoT Uu protocol stack of the relay wireless communication terminal and via a Uu protocol stack of the relay wireless communication terminal, wherein the IoT Uu protocol stack is used for a communication between the relay wireless communication terminal and the IoT wireless communication terminal, and the Uu protocol stack is used for a communication between the relay wireless communication terminal and the wireless communication node.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a node). In an embodiment, the wireless communication node may be implemented by using the wireless communication node 50 described above, but is not limited thereto.

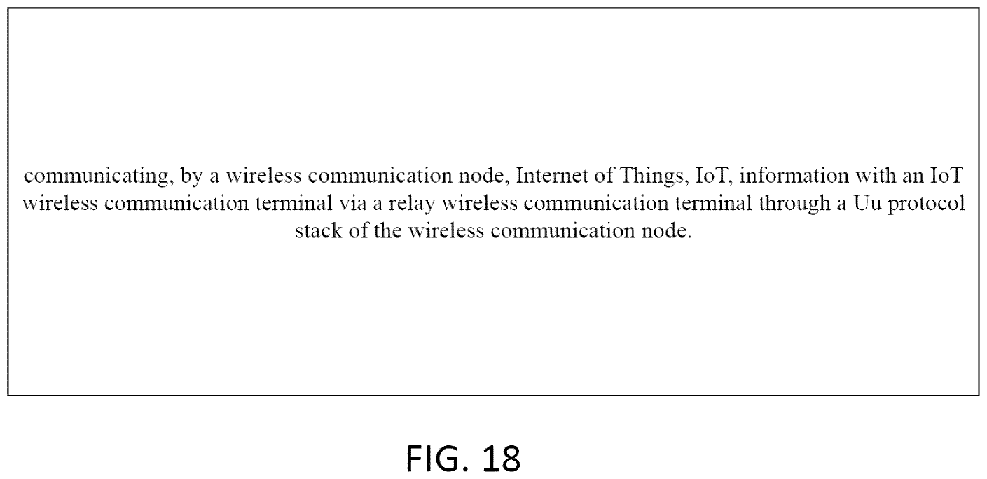

Referring to FIG. 18, in an embodiment, the wireless communication method includes communicating, by a wireless communication node, Internet of Things, IoT, information with an IoT wireless communication terminal via a relay wireless communication terminal through a Uu protocol stack of the wireless communication node.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., an IoT UE). In an embodiment, the wireless communication terminal may be implemented by using the wireless communication terminal 40 described above, but is not limited thereto.

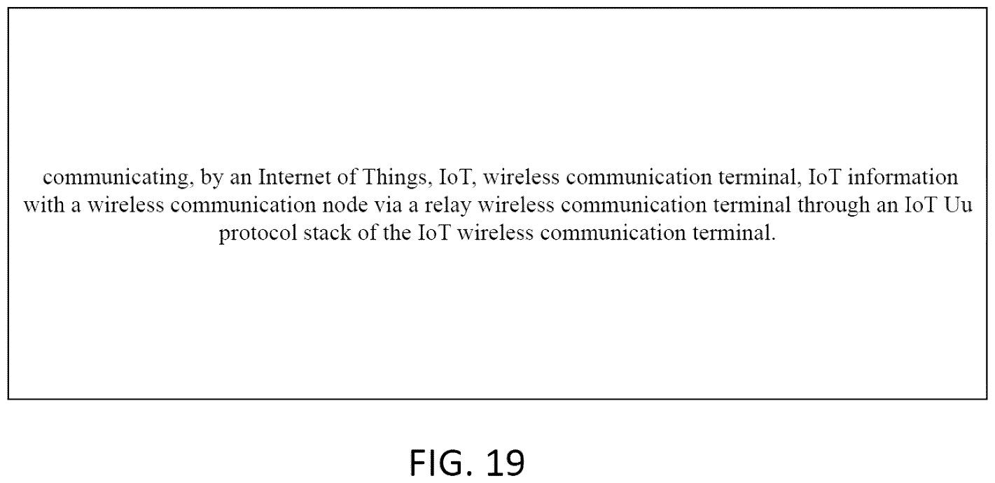

Referring to FIG. 19, in an embodiment, the wireless communication method includes: communicating, by an Internet of Things, IoT, wireless communication terminal, IoT information with a wireless communication node via a relay wireless communication terminal through an IoT Uu protocol stack of the IoT wireless communication terminal.

Details in this regard can be ascertained with reference to the paragraphs above, and will not be repeated herein.

In some embodiments, the IoT information used in the present disclosure may include at least one of: information of the IoT wireless communication terminal, information of the wireless communication node, information for the connection between the wireless communication node and the IoT wireless communication terminal, a configuration for the IoT wireless communication terminal, the data collected by the IoT wireless communication terminal, or an instruction for reading the data collected by the IoT wireless communication terminal.

In some embodiments, the IoT wireless communication terminal used in the present disclosure may indicate the IoT UE described above.

In some embodiments, the relay wireless communication terminal used in the present disclosure may indicate the relay UE described above.

In some embodiments, the wireless communication node used in the present disclosure may indicate the node, BS, or gNB described above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
relaying, by a relay wireless communication terminal, Internet of Things (IoT) information between a wireless communication node and an IoT wireless communication terminal via an IoT Uu protocol stack of the relay wireless communication terminal and via a Uu protocol stack of the relay wireless communication terminal,
wherein the IoT Uu protocol stack is used for a communication between the relay wireless communication terminal and the IoT wireless communication terminal, and the Uu protocol stack is used for a communication between the relay wireless communication terminal and the wireless communication node.

2. The wireless communication method of claim 1, wherein the IoT Uu protocol stack comprises at least one of:
an IoT Uu Layer 1 entity;
an IoT Uu Layer 2 entity or sub-entity; or
an IoT Uu Layer 3 entity.

3. The wireless communication method of claim 2, wherein
the IoT Uu Layer 1 entity performs at least one of a modulation, a demodulation, a channel coding, a channel decoding, a signal generation, a physical layer procedure, or a physical layer measurement for the communication between the relay wireless communication terminal and the IoT wireless communication terminal;
the IoT Uu Layer 2 entity or sub-entity performs at least one of a data transfer, a conflict resolution, an assembling, a dissembling, a radio resource selection, an encryption, a decryption, a control procedure, or a message generation for the communication between the relay wireless communication terminal and the IoT wireless communication terminal; and
the IoT Uu Layer 3 entity performs at least one of: an encryption, a decryption, a control procedure, or a message generation for the communication between the relay wireless communication terminal and the IoT wireless communication terminal.

4. The wireless communication method of claim 2, wherein the IoT Uu Layer 2 sub-entity adds or parses an IoT Uu Layer 2 header; and
wherein the IoT Uu Layer 2 header comprises at least one of: a source identifier (ID) of a data packet, a target ID of a data packet, a message type of a data packet, an identity of the IoT wireless communication terminal, an identity of the relay wireless communication terminal, or an identity of a destination network node of a data packet.

5. The wireless communication method of claim 1, wherein the Uu protocol stack comprises at least one of:
a physical (PHY) entity;
a Medium Access Control (MAC) entity;
a Radio Link Control (RLC) entity;
a Packet Data Convergence Protocol (PDCP) entity;
a Service Data Adaptation Protocol (SDAP) entity;
a Radio Resource Control (RRC) entity; or
a Layer B entity.

6. The wireless communication method of claim 1, wherein the relay wireless communication terminal performs at least one of:
receiving, by an IoT Uu Layer 1 entity, an uplink data packet from the IoT wireless communication terminal and retrieving a Layer 2 PDU or a Layer 2 sub-PDU;
delivering, by an IoT Uu Layer 2 entity or an IoT Uu Layer 2 sub-entity, a Layer 2 PDU or a Layer 2 sub-PDU to an SDAP entity, a PDCP entity, an RLC entity, an RRC entity, or a Layer B entity to generate an SDAP PDU, a PDCP PDU, an RLC PDU, an RRC PDU, or a Layer B PDU to be transmitted to the wireless communication node;
receiving, by a PHY entity, a downlink data packet from the wireless communication node; or
delivering, by an SDAP entity, a PDCP entity, an RLC entity, an RRC entity, or a Layer B entity, an SDAP PDU, a PDCP PDU, an RLC PDU, an RRC PDU, or a Layer B PDU retrieved from a downlink data packet from the wireless communication node to generate a Layer 2 PDU or a Layer 2 sub-PDU to be transmitted to the IoT wireless communication terminal.

7. The wireless communication method of claim 1, wherein the relay wireless communication terminal receives a configuration for a DRB, an RB, an RLC channel, or a Signal Radio Bearer (SRB) from the wireless communication node for the communication between the relay wireless communication terminal and the wireless communication node; and
wherein the configuration comprises at least one of:
a DRB identifier, ID;
a flow ID;
an RB ID;
an SRB ID;
an RLC channel ID;
a configuration of an SDAP entity;
a configuration of a PDCP entity;
a configuration of an RLC entity;
a configuration of a MAC entity; or
a configuration of a PHY entity.

8. The wireless communication method of claim 1, wherein the relay wireless communication terminal receives an IoT configuration from the wireless communication node for the IoT Uu protocol stack; and
wherein the IoT configuration comprises at least one of:
an IoT configuration ID;
a configuration of an IoT Uu layer 1 entity;
a configuration of an IoT Uu layer 2 sub-entity;
a configuration of an IoT Uu layer 2 entity; or
a configuration of an IoT Uu layer 3 entity; and
wherein the IoT configuration is associated with a configuration for a DRB, an RB, an RLC channel, or an SRB for the communication between the relay wireless communication terminal and the wireless communication node.

9. The wireless communication method of claim 1, wherein the relay wireless communication terminal performs the communication between the relay wireless communication terminal and the wireless communication node via an SRB with an RRC message, and the RRC message comprises at least one of:
an indication indicating that the RRC message is used for relaying a data packet from the IoT wireless communication terminal;
an indication indicating that a PDU carried by the RRC message is from the IoT wireless communication terminal;
a PDU from the IoT wireless communication terminal;
a source ID or a target ID;
an identity of the IoT wireless communication terminal;
a message type of the RRC message; or
information for at least one of an inventory or a contention resolution.

10. A wireless communication method comprising:
communicating, by a wireless communication node, Internet of Things (IoT) information with an IoT wireless communication terminal via a relay wireless communication terminal through a Uu protocol stack of the wireless communication node.

11. The wireless communication method of claim 10, wherein the Uu protocol stack comprises at least one of:
a physical (PHY) entity;
a Medium Access Control (MAC) entity;
a Radio Link Control (RLC) entity;
a Packet Data Convergence Protocol (PDCP) entity;
a Service Data Adaptation Protocol (SDAP) entity;
a Radio Resource Control (RRC) entity; or
a Layer B entity.

12. The wireless communication method of claim 10, wherein the relay wireless communication terminal receives a configuration for a DRB, an RB, an RLC channel, or a Signal Radio Bearer (SRB) from the wireless communication node for the communication between the relay wireless communication terminal and the wireless communication node.

13. The wireless communication method of claim 12, wherein the configuration comprises at least one of:
a DRB identifier, ID;
a flow ID;
an RB ID;
an SRB ID;
an RLC channel ID;
a configuration of an SDAP entity;
a configuration of a PDCP entity;
a configuration of an RLC entity;
a configuration of a MAC entity; or
a configuration of a PHY entity.

14. The wireless communication method of claim 10, wherein the relay wireless communication terminal receives an IoT configuration from the wireless communication node for an IoT Uu protocol stack; and
wherein the IoT configuration comprises at least one of:
an IoT configuration ID;
a configuration of an IoT Uu layer 1 entity;
a configuration of an IoT Uu layer 2 sub-entity;
a configuration of an IoT Uu layer 2 entity; or
a configuration of an IoT Uu layer 3 entity; and
wherein the IoT configuration is associated with a configuration for a DRB, an RB, an RLC channel, or an SRB for the communication between the relay wireless communication terminal and the wireless communication node.

15. The wireless communication method of claim 10, wherein the wireless communication node performs a communication between the relay wireless communication terminal and the wireless communication node via an SRB with an RRC message, and the RRC message comprises at least one of:
an indication indicating that the RRC message is used for relaying a data packet from the IoT wireless communication terminal;
an indication indicating that a PDU carried by the RRC message is from the IoT wireless communication terminal;
a PDU from the IoT wireless communication terminal;
a source ID or a target ID;
an identity of the IoT wireless communication terminal;
a message type of the RRC message; or
information for at least one of an inventory or a contention resolution.

16. A wireless communication method comprising:
communicating, by an Internet of Things (IoT) wireless communication terminal, IoT information with a wireless communication node via a relay wireless communication terminal through an IoT Uu protocol stack of the IoT wireless communication terminal.

17. The wireless communication method of claim 16, wherein the IoT Uu protocol stack comprises at least one of:
an IoT Uu Layer 1 entity;
an IoT Uu Layer 2 entity or sub-entity; or
an IoT Uu Layer 3 entity; and
wherein
the IoT Uu Layer 1 entity performs at least one of a modulation, a demodulation, a channel coding, a channel decoding, a signal generation, a physical layer procedure, or a physical layer measurement for the communication between the relay wireless communication terminal and the IoT wireless communication terminal;
the IoT Uu Layer 2 entity or sub-entity performs at least one of a data transfer, a conflict resolution, an assembling, a dissembling, a radio resource selection, an encryption, a decryption, a control procedure, or a message generation for the communication between the relay wireless communication terminal and the IoT wireless communication terminal; and
the IoT Uu Layer 3 entity performs at least one of: an encryption, a decryption, a control procedure, or a message generation for the communication between the relay wireless communication terminal and the IoT wireless communication terminal.

18. The wireless communication method of claim 16, wherein the IoT Uu Layer 2 sub-entity adds or parses an IoT Uu Layer 2 header; and
wherein the IoT Uu Layer 2 header comprises at least one of: a source identifier (ID) of a data packet, a target ID of a data packet, a message type of a data packet, an identity of the IoT wireless communication terminal, an identity of the relay wireless communication terminal, or an identity of a destination network node of a data packet.

19. The wireless communication method of claim 16, wherein the IoT wireless communication terminal receives an IoT configuration from the wireless communication node via the relay wireless communication terminal for the IoT Uu protocol stack; and
wherein the IoT configuration comprises at least one of:
an IoT configuration ID;
a configuration of an IoT Uu layer 1 entity;
a configuration of an IoT Uu layer 2 sub-entity;
a configuration of an IoT Uu layer 2 entity; or
a configuration of an IoT Uu layer 3 entity.

20. The wireless communication method of claim 16, wherein the IoT configuration is associated with a configuration for a DRB, an RB, an RLC channel, or an SRB for the communication between the relay wireless communication terminal and the wireless communication node.
